(19) United States
(12) Patent Application Publication
(10) Pub. No.: US 2008/0195433 A1
(43) Pub. Date: Aug. 14, 2008

(54) Dynamic Value Stream Mapping Software

(76) Inventors: James Robert Glenn, Blacksburg, VA (US); Kevin Dennis Creehan, Blacksburg, VA (US); Eileen Morton Van Aken, Blacksburg, VA (US); Richard Thomas Guy, Hendersonville, NC (US)

Correspondence Address: DORITY & MANNING, P.A., POST OFFICE BOX 1449, GREENVILLE, SC, 29602-1449, US

(21) Appl. No.: 11/839,792

(22) Filed: Aug. 16, 2007

Related U.S. Application Data
(60) Provisional application No. 60/822,558, filed on Aug. 16, 2006.

(51) Int. Cl. G06Q 10/00

(52) U.S. Cl. 705/7; 705/1

(57) ABSTRACT

Value stream mapping may be achieved by way of an application or software component that receives textual data defining a value stream (and/or other parameters of interest) and generates a value stream map. The application/component may additionally provide value stream analysis based on the received data and/or financial analysis. In some embodiments, multiple value streams may be defined and compared side-by-side.

### CROSS REFERENCE TO RELATED APPLICATION AND PRIORITY CLAIM

This Application claims the priority of U.S. Provisional Patent Application Ser. No. 60/822,558, Filed: Aug. 16, 2006, entitled DYNAMIC VALUE STREAM MAPPING SOFTWARE, which is incorporated herein by reference.

### BACKGROUND OF THE INVENTION

In today's business environments, much emphasis is put on lean production. Recent studies have indicated that nearly half of U.S. manufacturers are implementing lean production as their primary process improvement activity. The most popular tool for implementing lean production in an enterprise is value stream mapping. A value stream is the steps a business must take to provide the customer with the desired goods or services. A typical value stream begins with the initial customer order and ends with the final delivery. A value stream map is a tool that pictorially illustrates the flow of material and information as it moves through the value stream. A value stream map may reflect the current state or a future state of the business steps. Typically, businesses utilizing the value stream mapping technique for lean production and process optimization must first generate a current state value stream map. Then, future state maps may be generated reflecting potential changes or optimizations of the process for comparison with the current state.

One of the most noted drawbacks of value stream mapping is the time that is required to produce such maps. Traditionally, value stream mapping has been viewed as a “pencil and paper approach” that requires considerable time for drawing the map after gathering the necessary data from the production process. Further complicating this issue is the fact that each future state idea requires a separate map to be drawn. The time required to produce such maps oftentimes greatly diminishes the number of alternative future state ideas that are generated. Generally speaking, currently-available utilities can be deficient in several ways.

### SUMMARY AND OBJECTS OF THE INVENTION

In accordance with some embodiments of the present subject matter, value stream mapping may be achieved by way of an application or software component that receives textual data defining a value stream (and/or other parameters of interest) and generates a value stream map. The application/component may additionally provide value stream analysis based on the received data and/or financial analysis. For instance, charts, tables, and other output can be provided in addition to the value stream map. In some embodiments, cost/financial data can be input and cost/financial analysis output can be provided. In some embodiments, multiple value streams may be defined and compared side-by-side.

The present subject matter can address one or more deficiencies in currently-available products. For instance, a number of utilities have emerged in the marketplace to assist in completing value stream maps and decrease the amount of time required for lean conversion activities. However, other software utilities do not compute a visual representation of the product flow with an algorithm capable of analyzing each possible product flow route of the value stream. Generally, other software utilities are simply drawing aids, employing a drag-and-drop interface to assist the user in constructing the map. As a consequence, electronically creating value stream maps remains a very time consuming process. Secondly, current software products have very minimal or non-existent utilities to assist the user in analyzing the maps.

In some embodiments, a computerized method of value stream mapping can comprise displaying a user interface, wherein displaying comprises providing at least one data input form. The method can further comprise receiving textual data via the at least one data input form, with the textual data defining at least one value stream comprising a plurality of process steps. For instance, the value stream may be defined in terms of data defining paths between processes and data defining the processes (e.g. process time, materials, etc.). In some embodiments, the textual data can also define other data related to a value stream that is not directly associated with (or limited to) a single process.

In any event, the method can further comprise receiving a draw command (such as when a user provides input via, for instance, a clickable button), and, upon receipt of the draw command, computing a visual representation of a product flow and rendering at least one value stream map based on the received textual data. In some embodiments, the method can further comprise rendering at least one performance analysis chart for the data stream based on the received textual data. A “chart” can comprise any suitable other visual or textual representation of analysis output, including, but not limited to, tables and graphs. The chart(s) and map may be rendered, for example, on one or more suitable displays operably connected to a computing device.

For example, a plurality of icons can be arranged and displayed to a user via one or more displays. Additionally or alternatively, the map (and/or other output) can be provided in other forms, such as via a printout. The map can be annotated with data defining the value stream and input by the user. Additionally or alternatively, the map may be annotated with analysis results.

In some embodiments, the method can further comprise receiving textual data defining at least a first and second value stream, each stream comprising a plurality of process steps. The method can further comprise receiving cost and/or financial information associated with each value stream, and providing at least one cost comparison between the first and second streams. For instance, the first value stream may comprise a representation of a first state (e.g. a “current state”) while the second stream represents a second state (e.g. a “future state”). The cost comparison can comprise an indication of at least one of the internal rate of return and net present value of converting the value stream of the current state (i.e. the first state) to the future state stream (i.e. the second state). Thus, possible changes to a value stream can be effectively modeled to aid in the decision-making process.

In some embodiments, receiving textual data may comprise, for each process step, receiving data identifying the step, receiving data identifying one or more flow paths to the step (if any) and receiving data identifying one or more flow paths from the step (if any). Rendering the at least one value stream map can comprise displaying a plurality of icons each corresponding to a process step and connecting indicia corresponding to flow paths between steps. For instance, data identifying paths to and from a process step may comprise data that identifies, for a given process, one or more processes that precede and/or follow the given process. Further information may be received, including, but not limited to, execution time for a process, amount of material used and/or waste generated, personnel requirements, lead times, and the like. In some embodiments, rendering can comprise drawing a lead time ladder correlated to the value stream map.

In some embodiments, displaying a user interface can comprise displaying at least one data entry field for financial data or cot data, and the method can further comprise computing at least one cost measure for the value stream map. In some embodiments, the method can further comprise rendering at least one chart illustrating the at least one computed cost measure. The cost measure(s) can be stored for further analysis, such as comparison between various scenarios/maps.

Any embodiments of the method can be rendered as a computer software product. For example, computer-executable code can comprise program instructions rendered in at least one computer-readable medium such that the instructions, when executed by one or more computing devices, cause the computing device(s) to perform a method of value stream mapping. The method of value stream mapping can comprise, in some embodiments, displaying a user interface, with displaying comprising providing at least one data input form. The method can further comprise receiving textual data via the at least one input form, with the textual data defining at lest one value stream comprising a plurality of process steps (i.e. processes). In some embodiments, the textual data can also define other data related to a value stream that is not directly associated with (or limited to) a single process. In any event, the method can further comprise receiving a draw command and, upon receipt of a draw command, computing a product flow and rendering at least one value stream map based on the received textual data defining the value stream. In some embodiments, the computer-executable code comprises program instructions that cause the computing device(s) to provide additional functionality in accordance with the present subject matter, such as was discussed above. In any event, the code can be executed by a single computing device or by multiple computing devices adapted to function in concert.

In some embodiments, a computer system can comprise a display and at least one computing device, with the system adapted (by hardware and/or software, for example), to display a user interface, with displaying comprising providing at least one data input form, to receive textual data via the at least one data input form, with the textual data defining at least one value stream comprising a plurality of process steps (processes), and to receive a draw command. The computing device(s) can be adapted so that, upon receipt of the draw command, the device(s) compute a product flow and render at least one value stream amp based on the received textual data defining the at least one value stream. The device(s) may be further adapted to generate/render one or more performance analysis charts of any suitable type or format. Furthermore, the device(s) may be adapted to perform additional tasks related or unrelated to value stream mapping.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a step-by-step functional diagram in accordance with one embodiment of the present invention;

FIG. 2 is a value stream map of a current state formed according to Example 1.

FIG. 3 is a set of performance analyses of a current state formed according to Example 1.

FIG. 4 is a cost summary of a current state formed according to Example 1.

FIG. 5 is a value stream map of a future state formed according to Example 1.

FIG. 6 is a set of performance analyses of a future state formed according to Example 1.

FIG. 7 is a cost summary of a future state formed according to Example 1.

FIG. 8 is a comparison of current state with a future state formed according to Example 1.

FIG. 9 is a comparison of multiple future state scenarios formed according to Example 1.

FIG. 10 is a flowchart illustrating steps in an exemplary process for extracting data defining a value stream and creating a value stream map.

FIG. 11 is a flowchart illustrating steps in an exemplary process of extracting value stream cost data and creating one or more cost/financial analysis outputs.

FIG. 12 is an illustration of an exemplary computing device that can be used to implement one or more embodiments of the present subject matter.

### DETAILED DESCRIPTION

Reference will now be made in detail to various exemplary embodiments of the invention. The following descriptions of various embodiments are provided to better describe particular features of those embodiments and should not be considered as limiting the invention in any way to the particular features.

The invention relates to providing software that can automatically save, analyze, and draw value stream maps of both manufacturing and non-manufacturing activities. The software code may be written in any suitable language or languages, and the executable form of the software can be in any suitable number, type, or arrangement of components. For instance, in one embodiment, the software is written in Microsoft Visual Basic (e.g. Visual Studio 2005) as an application. In some embodiments, the application is for use in conjunction with a spreadsheet program such as Microsoft Excel (available from Microsoft Corporation of Redmond, Wash., USA). In such embodiments, input can be provided in, supporting calculations can be performed in, and output can be presented in one or more other tabs of the same spreadsheet. Of course, in other embodiments, the software can work in conjunction with other applications (in spreadsheet or other format) and/or may comprise a stand-alone application with its own input and display capabilities.

In any event, the software can be used to display a user interface, such as a data entry form, which guides the user through the data entry process of all necessary parameters required for the software to perform calculations to generate the value stream map. With the necessary data entry, the software runs one or more algorithms to compute the value stream map. The algorithm allows for very complex flows. For instance, in addition to flows, convergent flows, divergent flows, looping flows, parallel flows, swim lanes, and product that leaves the system (scrap) may be depicted. Furthermore, since the data required to produce a value stream map is saved (such as one or more files or in a database or databases), modifications may easily be made in order to create future state scenarios. This allows for “what-if” analyses to be conducted when examining potential improvement projects.

In addition to value stream maps, other informative charts, tables, and depictions may readily be constructed. For example, some charts and diagrams that may be constructed include:
Supplier Lead Time Chart: graphically illustrates the lead time of parts that are delivered by each supplier.
Cycle Time Diagram: illustrates the cycle time of each process compared with takt time to highlight processes that are not aligned with takt time.
Process Utilization Chart: shows the percentage of available time that is required to produce the necessary amount of production at each process. In addition, it highlights processes that are over utilized and underutilized.
Required Production Chart: accounts for scrap by showing the amount of monthly production that must be completed at each process in order to complete the final required production at the end of the value stream.

Further information may be portrayed graphically, in tables or charts, and/or in any other suitable form or forms. The information may include lead time summaries, cost summaries, and performance analyses. Monthly and per unit costs for the value stream may be calculated in specific categories, for example, in categories such as: Direct Labor, Overhead, Materials, Holding Cost, and Total Costs.

Additionally, in some embodiments, the software has the ability to provide a more comprehensive set of analysis capabilities. In one particular embodiment, the software contains a user form that allows for cost information to be compared between current and future state maps. The user can also enter an initial capital investment, interest rate, and project life and the internal rate of return and net present value of converting to each future state scenario may readily be computed. This versatility in the software is appealing to management since, in addition to computation and illustration of value stream maps, the software may also provide financial justification (or disincentive) for potential projects.

In some embodiments, the software may be used to link with a commercial simulation package such as Arena (available from Rockwell Automation of Warrendale, Pa., USA). In such embodiments, the software can automatically modify parameters of an existing model in Arena and run the simulation. At the conclusion of the simulation run, the results are transferred back to the graphical user interface to allow for comparisons to be made between deterministic and probabilistic behavior of the value stream.

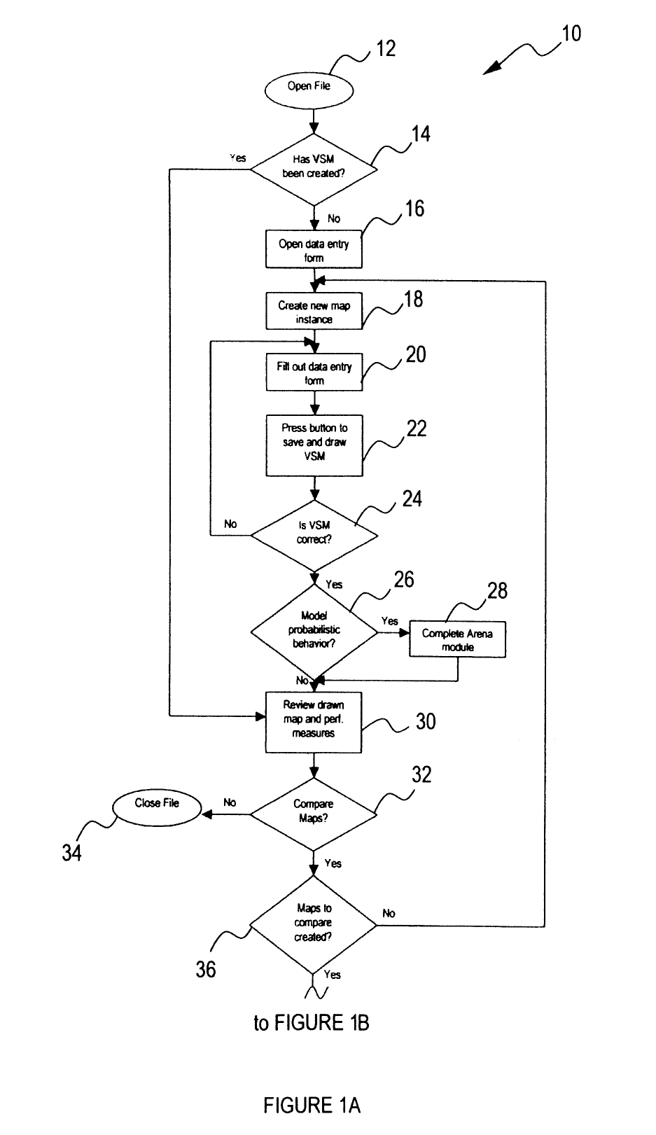

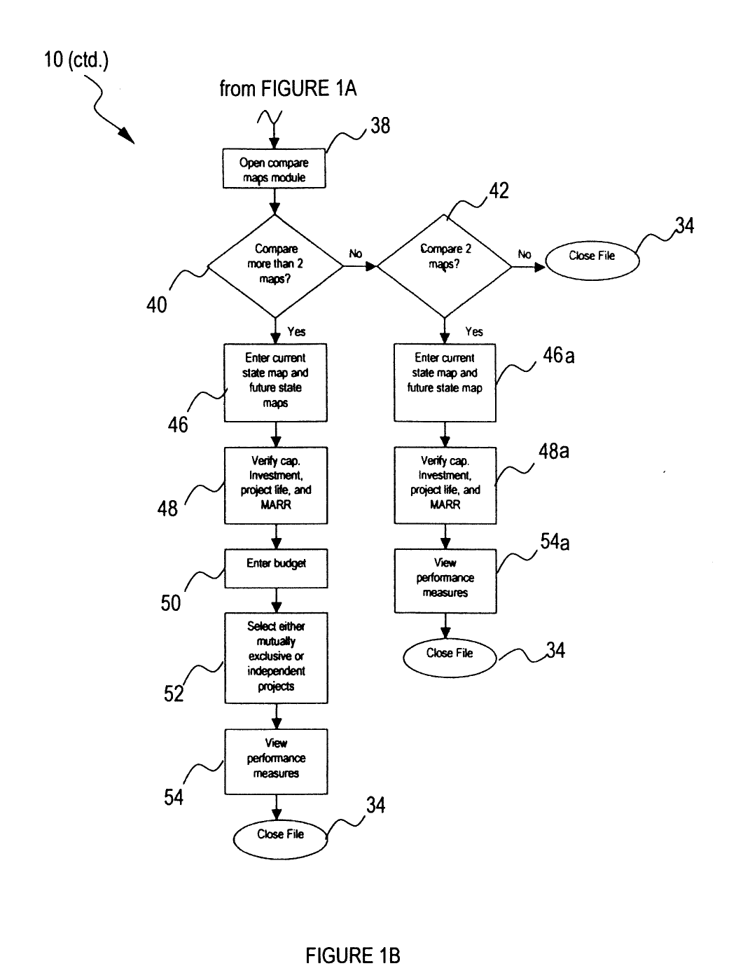

FIG. 1 illustrates a step-by-step functional diagram 10 showing steps performed in the course of utilizing one embodiment of the present subject matter. The software application(s) can be configured to receive input, perform analysis, and provide output in accordance any suitable sequence of operation, including the sequence of this example. In this embodiment, the user begins by starting the program by running one or more executable files, scripts, or the like as shown at step 12 (“open file”). If a value stream map was not previously computed (“Has VSM been created?”) 14, the user is presented with and/or opens one or more data entry forms as indicated at 16. For instance, the software may generate a user interface comprising one or more data entry forms, with each form comprising one or more fields for data entry. As shown at 18, if a new map is created, the user creates a new map instance and then enters data as shown at 20. For example, textual data may be entered into one or more fields associated with each process in the value stream and/or one or more other fields. Data may be entered in any suitable way, including, but not limited to, typing data into the form(s).

Examples of required information for the data entry form may include employee shift information and product demand (to compute takt time), process names, number of lines, processing time per line, cycle time per line, suppliers' names and the product or services supplied, routing information which includes the name of a first process followed by the name and percent of monthly demand of the following process(es) that the product or services enters, and queue information including the inventory type (uncontrolled, FIFO, buffer, supermarket, etc.) and quantity. Examples of optional information for the data entry form may include information flow such as process name, input, output, customer name, and customer delivery frequency, process information such as delay time, value added time, changeover time, batch size, availability percentage, machine reliability percentage, defect percentage, process type (such as value added, non-value added, or business value added), and swim lanes, supplier information such as delivery frequency and quantity delivered, and queue information such as transfer time and inventory time option (e.g. takt time or process cycle time). If the user wishes to include some financial analysis in the value stream map, yearly inventory holding cost percentage, unit sales price, capital investment, project life, minimum attractive rate of return, the total number of workers, work content per line, labor rate, overhead rate, and cost per unit of raw materials may be included. To aid usability, required information, optional information, and financial information may be separately denoted in the data entry form, for example, by color coding, and/or in any other suitable manner.

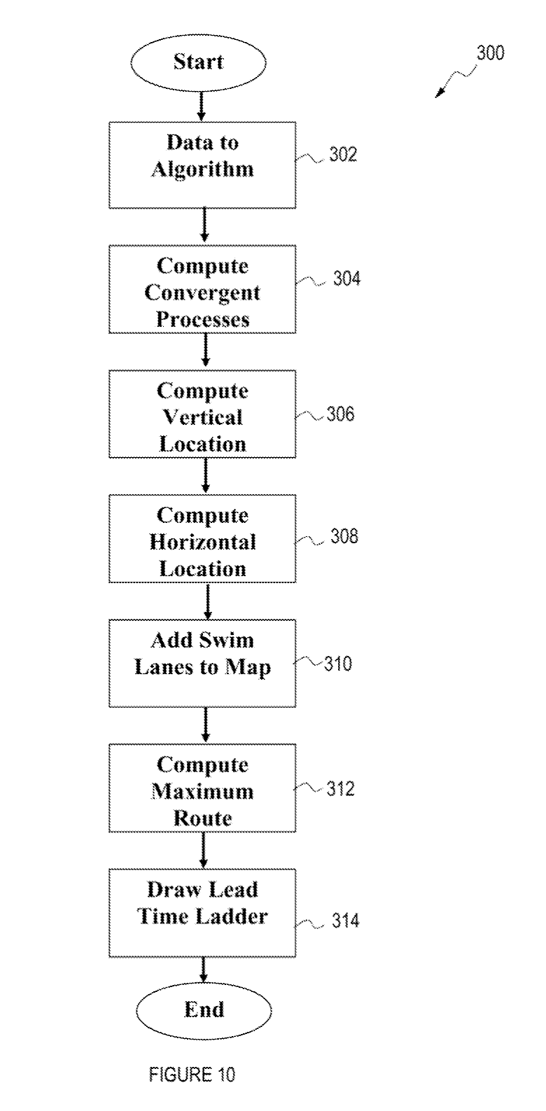

After the data entry form has been properly filled out, the user may then press the “Draw VSM” button 22, which invokes one or more drawing algorithms. If the required information has been properly entered, the one or more algorithms computes and draw the value stream map based on the data provided in the forms. Generally speaking, the algorithm can extract information defining each process and the relationships between processes in order to depict and annotate the value stream map. An example of a process that may be carried out by the algorithm(s) that generate the map is discussed below in conjunction with FIG. 10.

At 24, the user then examines the map (“Is VSM correct?”). If the map does not appear correct, the user may go back and edit the data input in the data entry form 20 and quickly redraw the map. If the map is correct, the user may then opt to model probabilistic behavior 26. If so, the user may input typical variability (for instance, two standard deviations) in various data inputs and run a simulation in a commercial simulation package, for example, Arena (“Complete Arena module”), or one or more other simulation packages as shown at 28.

As shown at 30, the user may then review the drawn map and performance measures. Then at 32, the user then determines whether they would like to compare the value stream map and performance measures to different scenarios (“Compare Maps?”). If the user only wishes to create the one value stream map, the objective is achieved at this point of the step-by-step functional diagram (“Close File”) 34. However, as shown at decision step 36, if the user wishes to compare to additional maps (“Maps to compare created?”), such as one or more future state maps, the user reverts back to the data entry form 16 and creates a new map instance 18.

Once all value stream maps have been created, the user may opt to utilize a “compare maps” module 38 in the software. The user then determines how many maps they would like to compare (“Compare more than 2 maps?”) as shown at 40. Step 42 represents a decision: if the user wishes to compare two maps, the user enters the current state and future state map as shown at 46a, inputs the capital investment, project life, and Minimum Attractive Rate of Return (MARR) as shown at 48a, and views the performance measures as shown at 54a. If the user does not wish to compare two maps (i.e. does not want to compare any maps in this example), then the file is closed as shown at 34.

If a comparison is performed, the comparison between the maps may include various categories such as a performance summary including production lead time, value added time, and overall value added percentage, sales including production volume, average unit sales price, and total sales, and costs including direct labor costs, overhead costs, materials costs, inventory holding costs, and total costs. With total sales and total costs, gross margin may also be computed. If capital investment and project life has been included, the internal rate of return and net present value of the future state scenario is additionally computed. After viewing the performance measures the objective is achieved and the file is closed as shown at 34.

Referring back to step 40, if a user wishes to compare more than two maps, then the user enters the current state and future state map(s) as shown at 46, inputs the capital investment, project life, and MARR for each future state as shown at 48, enters a budget and/or any other financial/investment information as 50, and selects whether the future state projects are either mutually exclusive or independent projects 52. The user may then click the “Calculate Action” button. The software then readily determines which future state scenario is most financially beneficial and recommends the appropriate action. After viewing the performance measures 54, the objective is achieved and the file is closed 34.

Although not specifically noted above, the underlying data defining the value stream, financial data/assumptions, and output results may be saved as one or more files for later reference/manipulation at any time. Additionally, although the above example generally pertained to creation of a new value stream map, one or more existing files can be opened or data can otherwise be imported and then updated through manipulating data defining the value stream in the input form(s).

### EXAMPLE 1

Assume for this example that a hypothetical value stream including seven processes is desired to be modeled. This value stream comprises the following processes: Stamping, Welding, Automatic Paint, Assembly #1, Manual Paint, Assembly #2, and Shipping steps. Process data including processing time, cycle time, and changeover time for each step are listed in Table 1.

TABLE 1
Process Data

| Process | | Processing | Cycle | Changeover Time |
|---|---|---|---|---|
| Number | Process Name | Time (s) | Time (s) | (min) |
| 1 | Stamping | 53 | 53 | 30 |
| 2 | Welding | 47 | 47 | 30 |
| 3 | Automatic Paint | 45 | 45 | 30 |
| 4 | Assembly #1 | 52 | 52 | 30 |
| 5 | Manual Paint | 48 | 48 | 30 |
| 6 | Assembly #2 | 50 | 50 | 30 |
| 7 | Shipping | 34 | 34 | 30 |

In this example, 100% of the product goes through the Stamping and Welding processes. After completion of welding, 70% of the product goes to the Automatic Paint process and the remaining 30% enters the Manual Paint process creating parallel processing of different types of product variants. Additionally, 5% of the product must be recycled to the Automatic Paint process for rework. Furthermore, approximately 10% of the product does not meet customer specifications and cannot be reworked after exiting Assembly #2 process. Thus, this 10% of product is scrap.

The following stream and process characteristics are input into the data entry form(s) of the software. Additional known information including product demand and amount of working time for the value stream (for use in computing takt time which may be automatically computed for the user in the data entry form) and product queue for each process are also input. Other optional information including, for example, customer name and customer delivery frequency, process information such as delay time, value added time, batch size, availability percentage, machine reliability percentage, defect percentage, process type (such as value added, non-value added, or business value added), and swim lanes, supplier information such as delivery frequency and quantity delivered, and queue information such as transfer time and inventory time option (e.g. takt time or process cycle time). Furthermore, financial data such as yearly inventory holding cost percentage, unit sales price, capital investment, project life, minimum attractive rate of return, the total number of workers, work content per line, labor rate, overhead rate, and cost per unit of raw materials may be input into the data entry form.

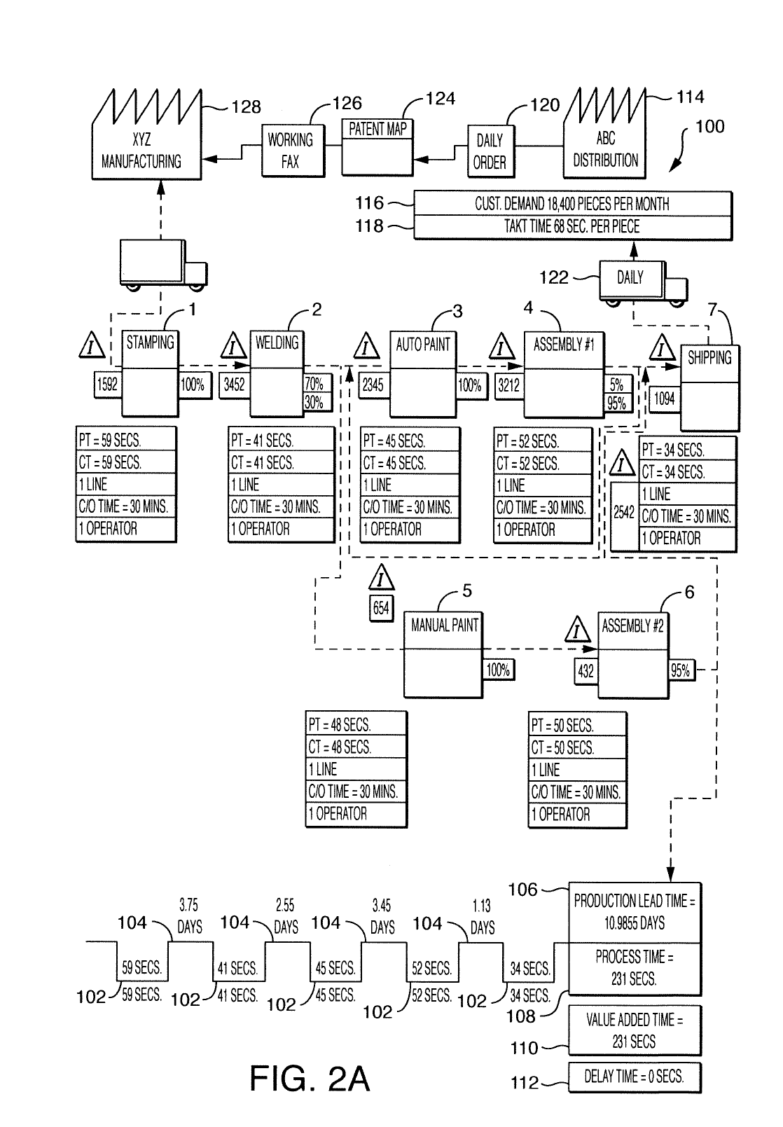

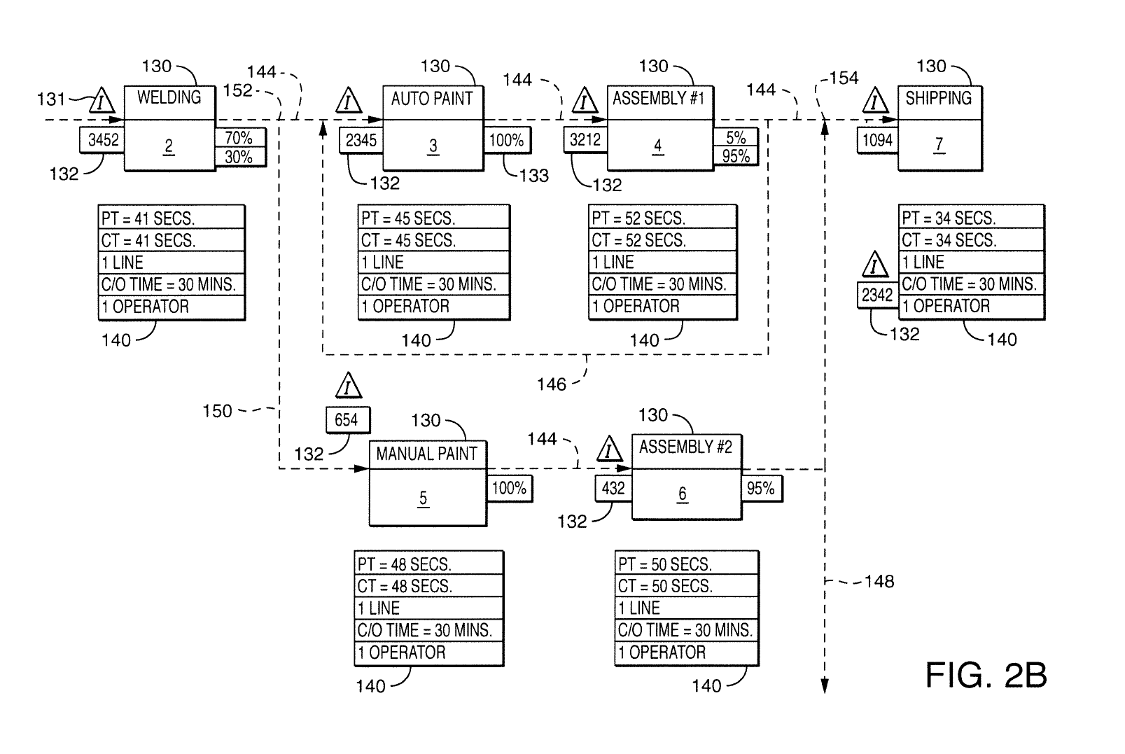

After inputting the data, the user may click the “Draw Map” button or otherwise provide a suitable commend directing the software to generate a value stream map. FIG. 2a depicts an exemplary “current state” value stream map 100 that can be generated in some embodiments based on the example data above. Note that information including value added time 102 for each process step, amount of time product remains in queue 104 for each process step, production lead time 106, overall process time 108, overall value added time 110, and delay time 112 may be computed and displayed on the map for convenience. An abundance of other information may be present on the map including customer information such as name 114, customer demand 116, takt time 118, the frequency of orders 120, and the frequency of product delivered to the customer 122, description of the process 124, frequency of orders to suppliers 126, names of suppliers 128. FIG. 2b depicts an enlarged section of FIG. 2a (corresponding to the portion depicting processes 2-7) and illustrates information that may be included on the value stream map 100 for each process step including the process step description 130, amount of product in queue at each process step 132 (along with input indicator icon 131), and a process step information box 140 including information such as process time (PT), cycle time (CT), number of lines, change over time (C/O Time), and number of operators. Furthermore, indicator 133 illustrates how much product flows through a particular path (or paths) leading from each process. On this particular value stream map 100, sequential flows 144, loop flow 146, product scrap flow 148, parallel flow 150, divergent flow 152, and convergent flow 154 are depicted.

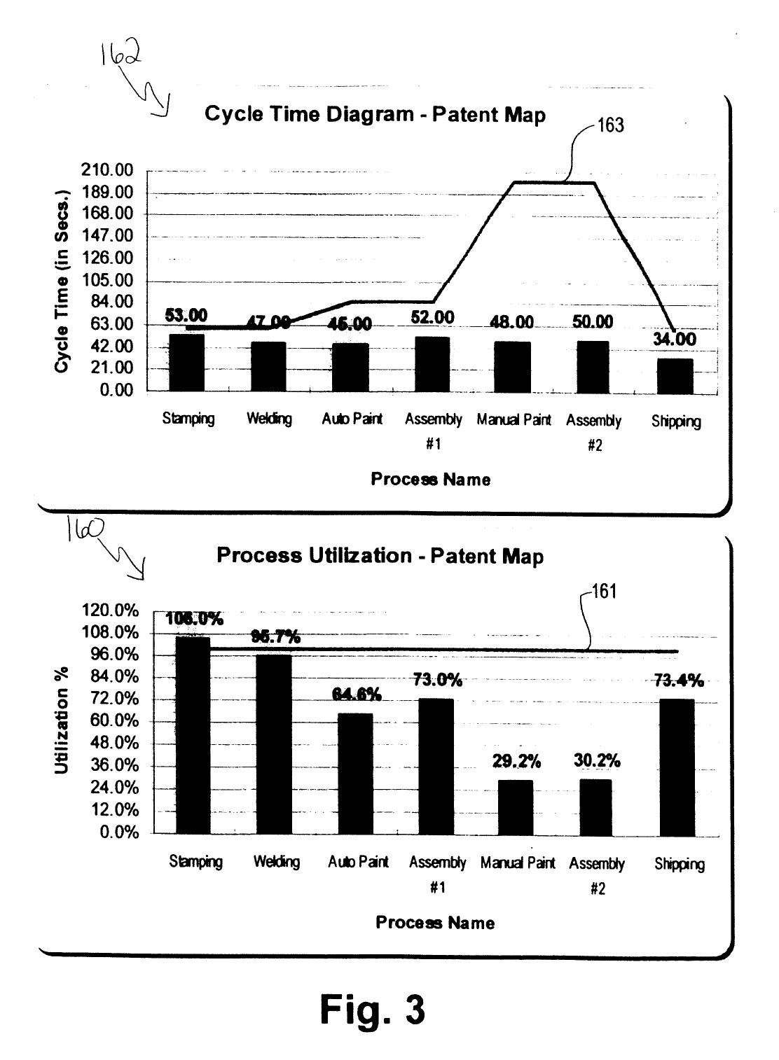

In addition to the value stream map, a set of performance analyses may be generated. In this example, process utilization chart 160 and cycle time chart 162 for each step of the current state is illustrated in graphical form in FIG. 3. In chart 162, line 163 represents the takt time and line 161 in chart 160 represents 100% process utilization. Although the performance analyses in these examples comprise charts, any other suitable manner of conveying information can be used, including tables, graphs of any type, and the like.

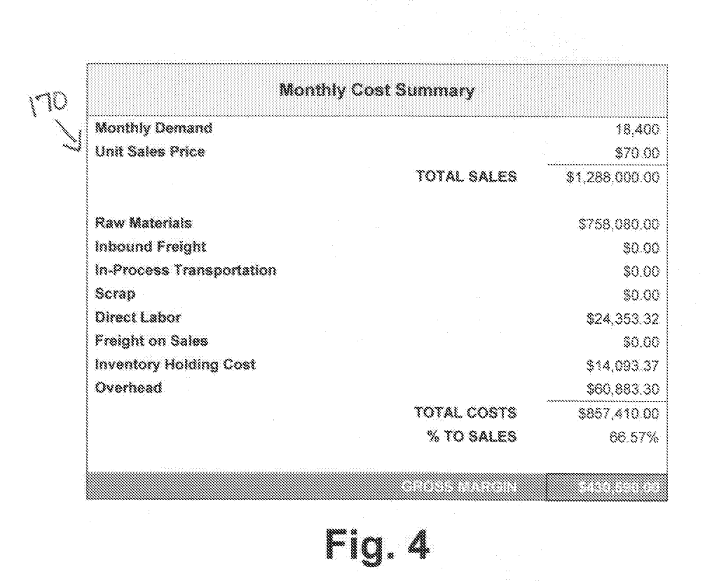

In some embodiments, the software has the capability of building a cost model into each value stream that it generates. A cost summary chart 170 for this value stream map example is illustrated in FIG. 4. Among other things, the cost model can be used to generate a prediction of the Gross Margin 172 for the situation being analyzed. Generally speaking, the cost model and other financial analysis output can be generated by one or more algorithms that model data using standard financial analysis equations and principles. The underlying data for such models can be harvested from additional data entry fields in the entry form(s) for each process and other aspects of the value stream(s) being modeled. Additionally, financial/investment information external to the value stream (e.g. capital rate of return, available funds, etc.) can be provided in one or more additional forms/fields prior to the cost/financial analysis.

Upon construction of the value stream map, the user can readily review all of the data generated by the software in order to identify potential improvement areas. Some problem areas and potential corrective actions in this example are listed in Table 2.

TABLE 2
Potential Issues and Corrective Actions of the Current Situation

| Future | | |
|---|---|---|
| State | | |
| Scenario | | |
| Number | Potential Issue | Potential Corrective Action |
| 1 | The Stamping process is over- | Undergo a changeover reduction |
| | utilized with a utilization of 106%. As | project at Stamping with the |
| | a result, it may not be possible to | objective of reducing changeover |
| | consistently produce the required | time from 30 minutes to 10 |
| | output without running overtime. | minutes. |
| 2 | The Manual Paint and Assembly #2 | Combine Manual Paint and |
| | operations are heavily under- | Assembly #2 into a single |
| | utilized, with utilizations of 29.2% | process (labeled as 8) that |
| | and 30.2% respectively. | performs both activities. |
| 3 | Rework loops are not an ideal | Use an approach such as Six- |
| | situation, as the same product must | Sigma in order to eliminate |
| | be processed at a given process | product that must be reworked. |
| | more than one time. | |

With potential corrective action ideas, the user may readily create one or more Future State scenarios. For example, the data defining the “Current State” example above may be copied over / saved into a new map instance. Then, the user may manipulate the data as desired, direct the software to draw the Future State scenario(s), and analyze the performance set(s) and cost model(s) that is generated in order to predict the impact of making the proposed corrective action.

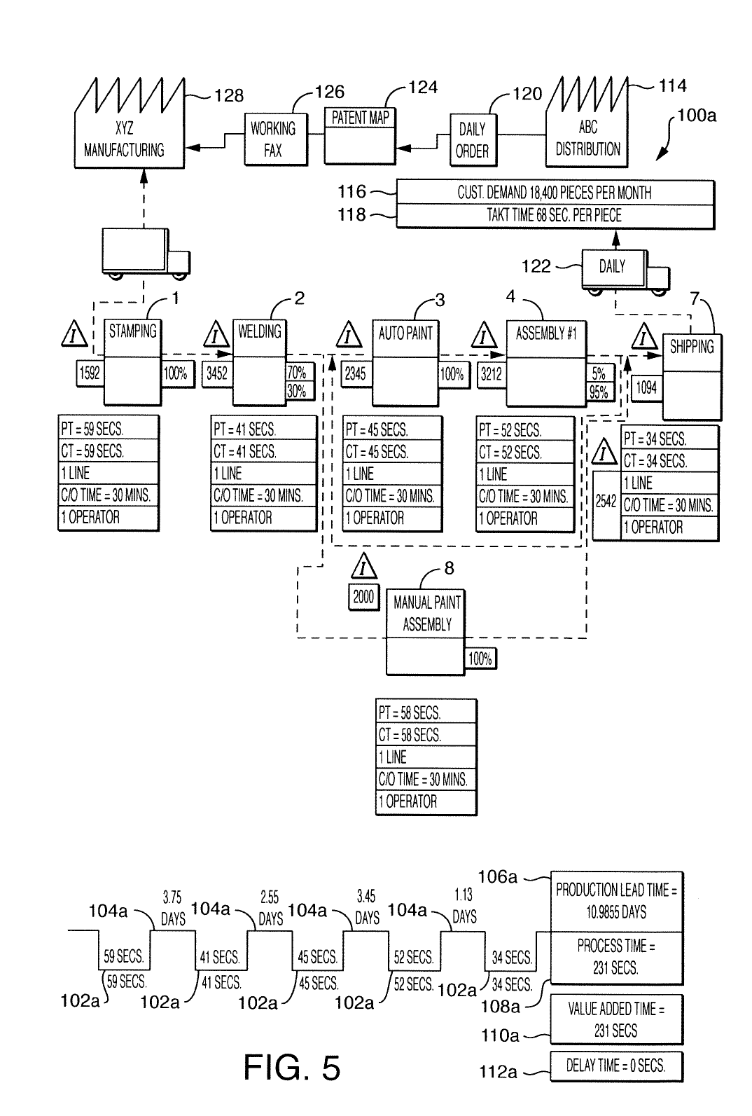

For example, assume that three Future State scenarios corresponding to the three potential corrective actions identified in Table 2 are to be generated. For illustrative purposes, the updated value stream map a sampling of exemplary analysis output generated for Future State Scenario #2 (in which processes 5 and 6 are combined into a single paint/assembly step 8) are depicted in FIGS. 5-7.

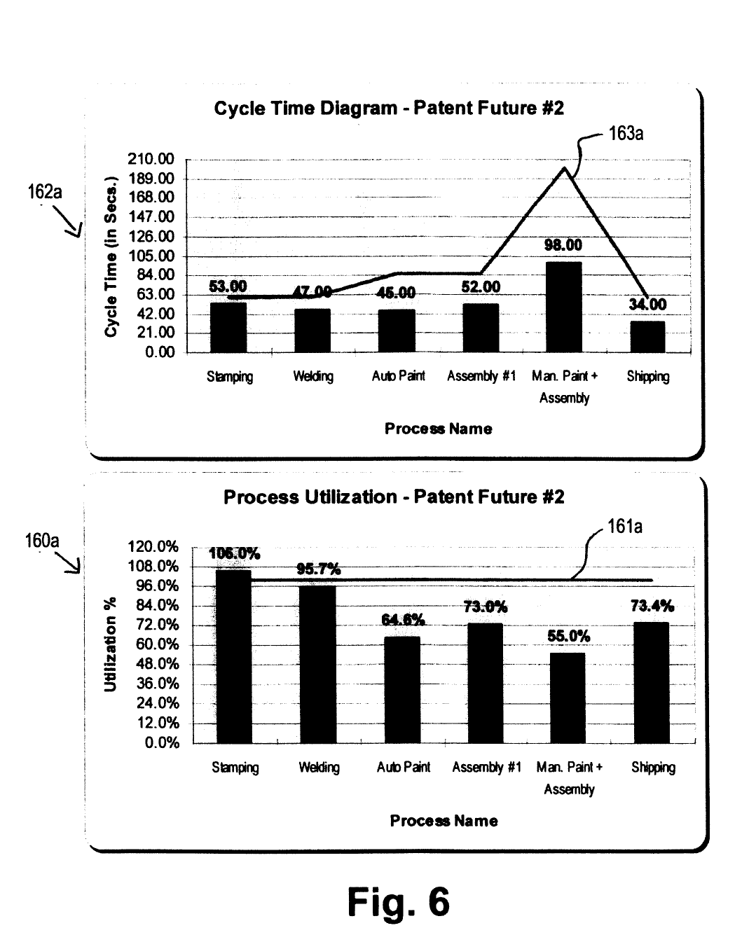

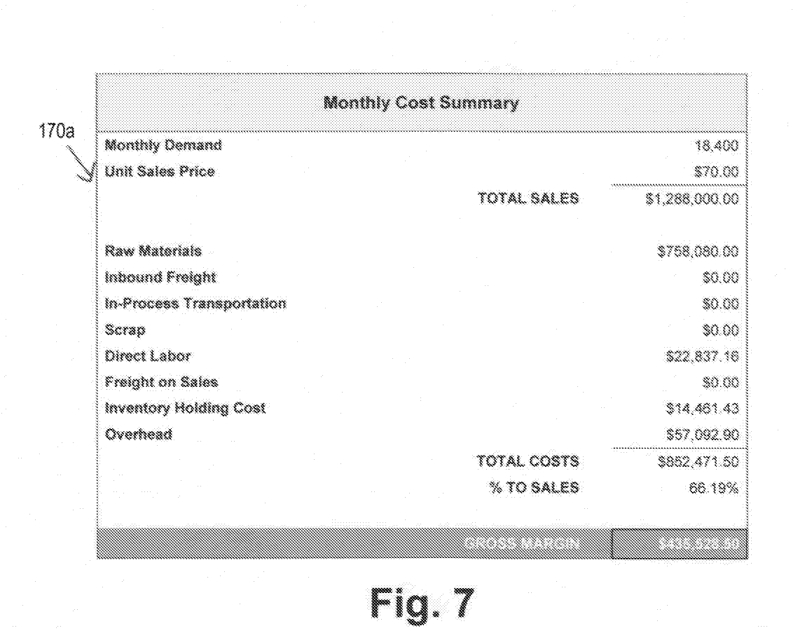

Specifically, in FIG. 5, the new value stream map 100a reflects Future State Scenario #2. Indicators such as value added time 102a for each process step, amount of time product remains in queue 104a for each process step, production lead time 106a, overall process time 108a, overall value added time 110a, and delay time 112a may reflect very different, similar, and/or some of the same values depending upon the extent of changes in process parameters. Furthermore, FIGS. 6-7 show appropriate changes in an updated process utilization chart 160a, updated cycle time chart 162a, and updated cost summary 170a indicate changed results in Future State Scenario #2. In FIG. 6, line 163a represents takt time while line 161a represents 100% process utilization. For instance, the projected Gross Margin 172a of Future State Scenario #2 has increased as compared to the Gross Margin 172 of the Current State situation. For this hypothetical example, it is revealed that combining the Manual Paint and Assembly #2 operations enables more efficient use of labor resources resulting in a reduction of direct labor cost.

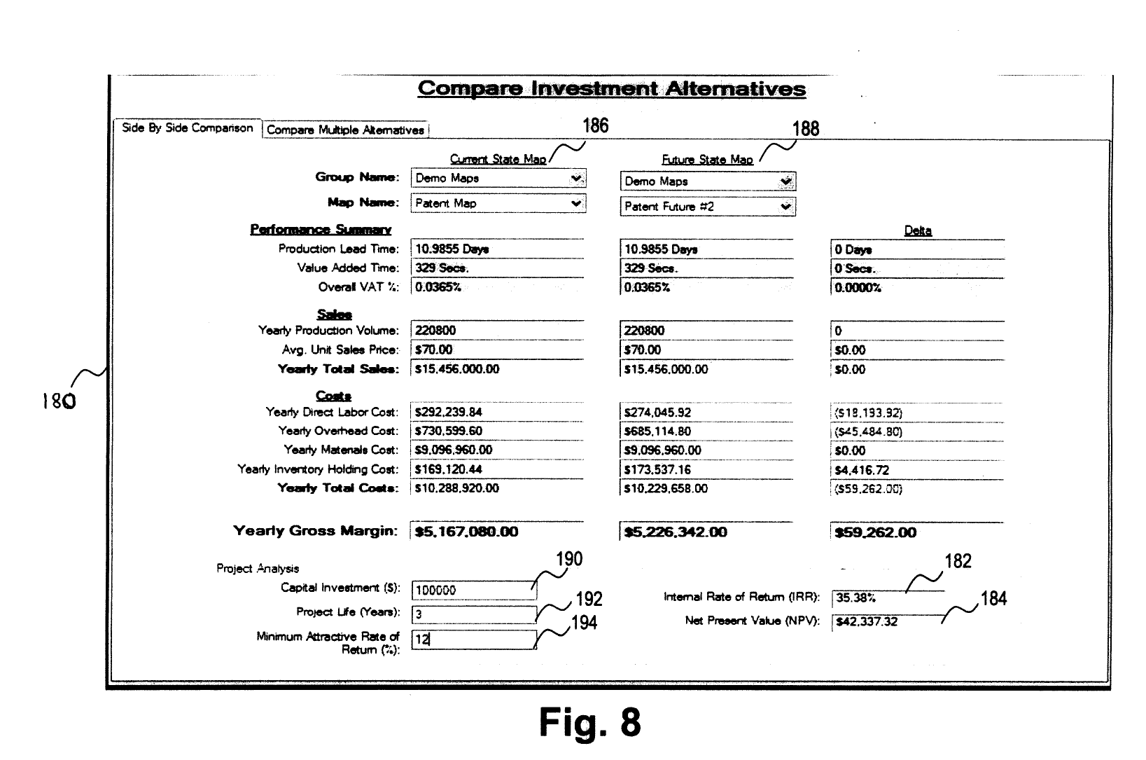

FIG. 8 illustrates an analysis tool 180 that may be utilized to compare two maps. The software may also enable the user to compute the projected Internal Rate of Return 182 and Net Present Value 184 of converting from the Current State situation 186 to a Future State scenario 188. For instance, in this example, the user may enter assumptions for Future State Scenario #2 such as capital investment 190 to make the change to the Future State scenario, the project life 192, and the MARR 194 that must be obtained to make completing the project a worthwhile use of financial resources. Assuming a project cost 190 of $100,000, receiving a financial benefit 192 of 3 years, and a MARR 194 of 12%, the Future State scenario 188 may readily be compared to the Current State 186. The Internal Rate of Return 182 and Net Present Value 184 of changing to Future State Scenario #2 is projected at 35.38% and $42,337.92 respectively.

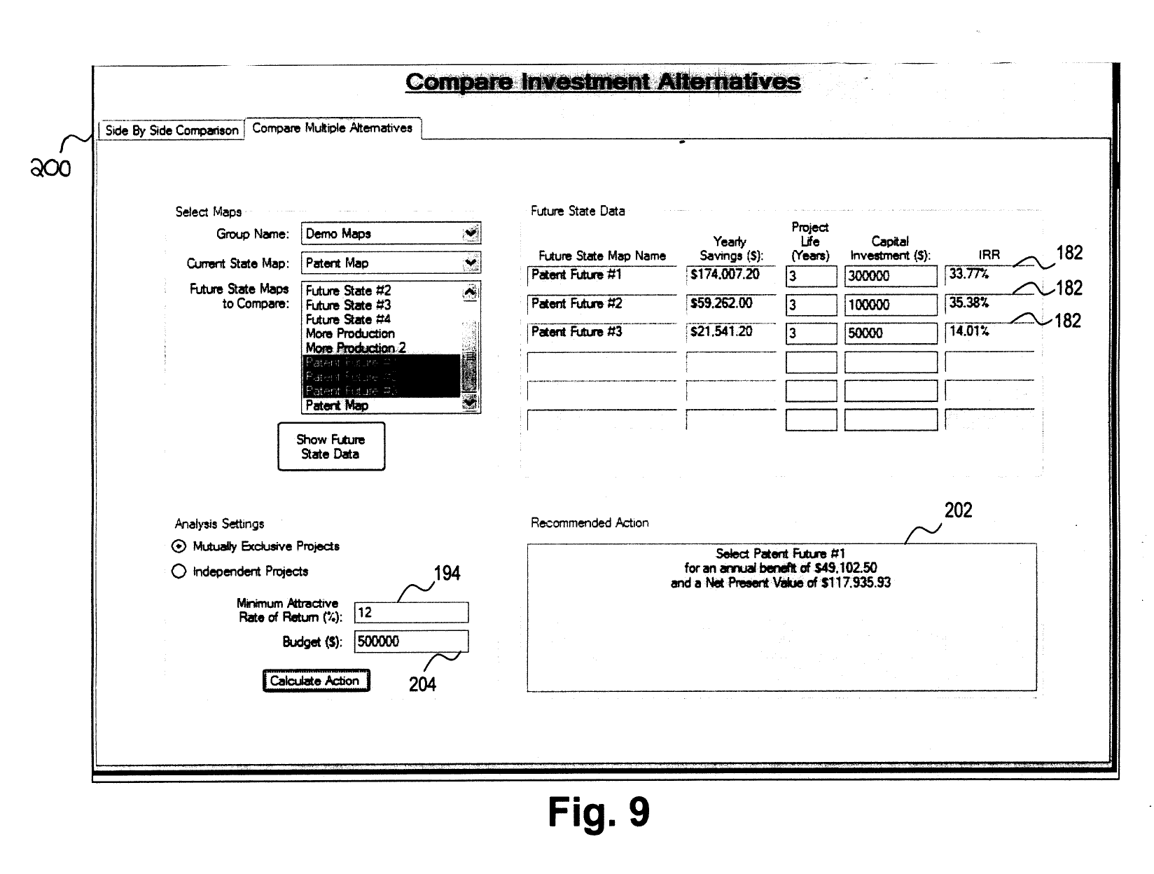

Additionally, if the user wishes to compare multiple Future State scenarios, for instance Future State Scenario #1, 2, and 3 in this example, the software may provide for comparison of multiple scenarios at once in order to assist the user in selecting the project with the greatest impact. The three Future State scenarios comparison 200 is illustrated in FIG. 9. In this example, it is found that the projected Internal Rates of Return of converting to Future State Scenario #1, Future State Scenario #2, and Future State Scenario #3 are 33.77%, 35.38%, and 14.01% respectively.

Based upon these Internal Rates of Return and the Capital Investment that is required to complete the projects, the software can provide one or more indicators of a recommended action 202. Here, it is determined that Future State Scenario #1 is projected to be the single most worthwhile project to implement. While Future State Scenario #2 yielded a slightly higher Internal Rate of Return, Future State Scenario #1 yielded the return on a much larger investment. The best project should be selected upon the Internal Rate of Return and the amount of initial investment; however, the ultimate decision will of course depend on the circumstances of the entity (or entities) performing the value stream mapping/analysis. It should be noted, however, that if the Future State projects were not mutually exclusive in this example, and completion of multiple projects could be accomplished within budget 204, then all three scenarios would be recommended since the Internal Rate of Return of each Future State Scenario is higher than the MARR.

FIG. 10 is a flowchart depicting steps in an exemplary embodiment 300 of a process for rendering one or more value stream maps based on textual data defining the value stream(s). In the following discussion, a single algorithm is discussed, although it will be understood that one or more algorithms, each comprising one or more sub-processes in some instances, may be used. At 302, data is provided to the algorithm. For example, an array can be generated corresponding to each process that is to be represented in a value stream map, with the data of the array extracted from corresponding fields in the data entry form(s) where one or more users have provided data defining the value stream. Additionally, an array defining all possible route segments in the value stream map can be generated. For instance, each route segment can be identified by the process at the beginning of the route segment and the process at the end of the route segment.

At 304, based on the data defining the value stream, convergent processes can be identified. A convergent process can comprise any process at which parallel flows converge. For instance, the convergent processes can be identified in an array identifying every process in the value stream with an indicator (such as a “Yes” or logical TRUE) denoting convergent processes.

At 306, the vertical location for each process can be determined. For example, a value stream map can comprise one or more rows. For a single sequential flow, all processes will be placed on the first row (assuming sufficient display space does not require overlap). In value streams comprising parallel flow paths, the parallel flows can be placed on respective rows. In some embodiments, for each process, the position of a previously-positioned process can be tracked. Additionally, the number of route segments that exit a process can be tracked so that route segments can be positioned properly. For example, in some embodiments, for a process with I route segments, the Ith route segment can be placed (i−1) rows below the process that the route segment originates from. Additionally, processes identified as “convergent” can be placed on the lowest row number of any other process that has a route segment entering the convergent process.

At 308, the horizontal location of processes can be determined. For instance, the amount of space between processes within a row can be calculated so that the processes are spaced equidistant. Furthermore, other mapping rules can be implemented, such as placing processes that split off (i.e. processes in divergent flows) directly under the process(es) from which they diverge.

Once a horizontal and position for each process (and/or any other non-process component) is determined, an appropriate icon or icons associated with each process can be selected and placed at the proper location. Information from the process's respective array (e.g., label, time indicator, etc.) can then be added to annotate the icon.

At 310, swim lanes can be added to the map by calculating the number of swim lanes and generating an array indicating the number of rows of processes located in each swim lane. Vertical positions of processes may be adjusted so that each process is located in a designated swim lane.

At 312, the maximum route can be calculated. For instance, based on the array of all possible route segments (see 302 above), each possible route between the beginning of the value stream and the end of the value stream can be determined. By summing processing times input with data defining each process, the total route time for each route can be calculated. The route with the maximum route time can be returned.

At 314, a lead time ladder can be drawn. The lead time ladder can comprise an indication of the processing time at each horizontal location on the map for processes along the maximum route. For rework loops, the processing time can be multiplied by the total number of times the rework process(es) are visited along the maximum route. The value added time for each process can also be placed at respective horizontal locations along the route, with value added time multiplied for re-work processes. In some embodiments, the inventory time that feeds each process along the maximum route can also be placed horizontally prior to each process.

In some embodiments, the production lead time for the value stream map can be calculated. For instance, this may be achieved by summing together each component processing time along the maximum route with each component inventory time along the maximum route. Furthermore, the total process time and total value added time can be provided by summing each component processing time and value added time along the maximum route.

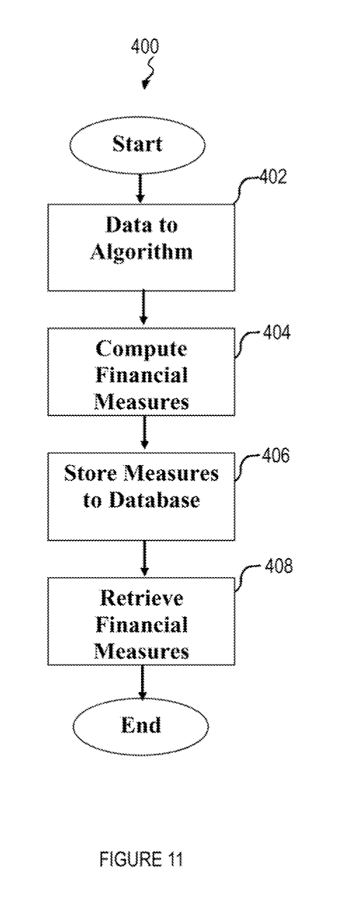

As was noted above, in some embodiments the software can displaying a user interface with one or more forms comprising at least one financial data entry field. Based on cost date entered into such field(s), the software can compute one or more cost measures for the value stream map. FIG. 11 illustrates a process 400 comprising exemplary steps whereby cost measures can be computed. For example, process 400 may be a part of the algorithm that renders a value stream map and/or may represent steps of a separate cost analysis algorithm. In any event, at 402 data is provided to the algorithm. For instance, as was noted earlier, a user can enter information in a number of financial or cost fields in the data entry form or forms used to define a value stream. Some fields may relate to process-specific information (such as average direct labor rate for a given process) while others comprise global values applicable throughout the model (such as inventory holding cost percentage). Some fields may be specific to the product(s) that are the subject of the value stream, such as the average cost per piece for a product coming in from a supplier. In any event, in some embodiments, upon receipt of a draw command (such as the user clicking the “Draw VSM” button), each value may be brought into the algorithm as a series of array variables.

At 404, financial/cost measures can be computed. For instance, each process-specific cost measure may be summed together in order to compute a total cost for the entire model. For example, the total direct labor cost for the entire model can be determined by summing together the direct labor cost provided for each process. Similarly, product specific cost measures can be summed together in order to compute a total product cost. For example, the total raw material cost can be computed by summing together raw material costs for each supplied product.

At 406, the computed cost measures for a value stream map can be stored in one or more files (such as in a database) for future reference and use by the program. For instance, in some embodiments, cost measures depicted in FIG. 4 can be computed and displayed. Of course, other cost measures can be computed depending upon the available data, and the resulting cost measures can be displayed in any suitable form(s), including, but not limited to, charts.

Step 408 represents return of the computed cost measures for each map when the software receives input from a user requesting comparisons of maps or alternatives. As will be understood, in some embodiments, step 408 is not carried out unless/until such a request is made. For instance, the software may render one or more charts (or other representation(s)) illustrating the computed cost measure(s). Additionally, in some embodiments, to the extent that computed cost/financial information is displayed on a value stream map, such information can be retrieved as the map is drawn.

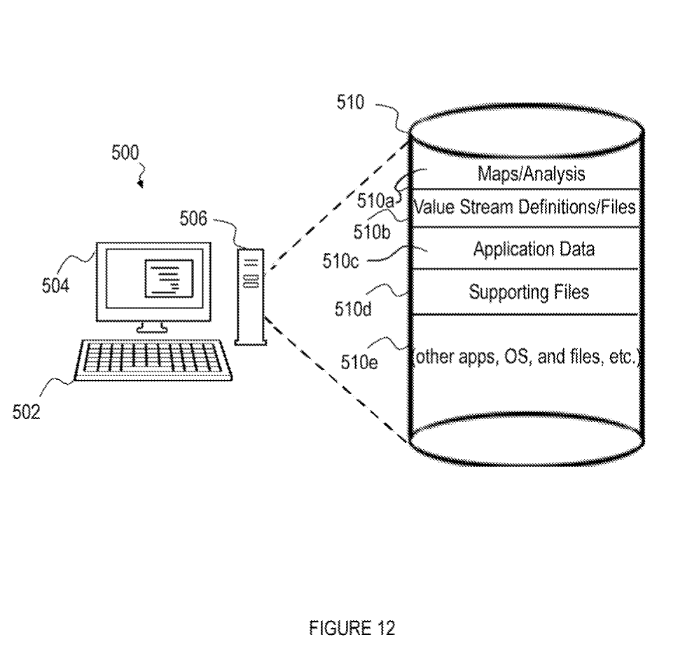

FIG. 12 depicts an exemplary computing system 500 that may be used to implement aspects of the present subject matter. For instance, in this example, a desktop computer comprising a display 504, keyboard 502, and CPU/memory 506 is utilized. For instance, system 500 may comprise a personal computer (PC) running Microsoft Windows, Mac OS, Unix, Linux, and/or another operating system. One or more applications may be used and configured in accordance with the present subject matter to allow users to provide data for value stream mapping and analysis.

510 symbolically represents the contents of memory accessible by system 500. Namely, memory 510 comprises data corresponding to one or more value stream maps and analysis 510a, value stream definitions and files 510b (such as data provided via input forms), application data 510c (such as one or more executable files that generate maps and analysis based on input data), and supporting files 510d (such as value stream map icons). Furthermore, since in this example a general-purpose computing system 500 is illustrated, memory 510 further comprises other applications, operating system(s) and other computer files illustrated generally at 508e. Memory 510 may comprise any suitable computer-readable medium or media and may, for example, comprise a combination of disk drives (e.g. magnetic or flash drives) and memory (e.g. cache, RAM, and the like). Although not illustrated in this example, system 500 may comprise additional input and output devices, including pointing devices (e.g. a mouse or pen tablet), microphone(s), camera(s), speakers, and multiple displays. Computing system 500 may connected to one or more networks through any suitable wired, wireless, and/or other connections. Of course, it will be recognized that other computing system architectures can be used to implement embodiments of the present subject matter.

The various computer systems discussed herein are not limited to any particular hardware architecture or configuration. Embodiments of the methods and systems set forth herein may be implemented by one or more general-purpose or customized computing devices adapted in any suitable manner to provide desired functionality or caused to perform certain actions. The device(s) may be adapted to provide additional functionality complementary or unrelated to the present subject matter, as well. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, some embodiments of the methods and systems set forth herein may also be implemented by hard-wired logic or other circuitry, including, but not limited to application-specific circuits. Of course, combinations of computer-executed software and hard-wired logic or other circuitry may be suitable, as well.

Embodiments of the methods disclosed herein may be executed by one or more suitable computing devices. Such system(s) may comprise one or more computing devices adapted to perform one or more embodiments of the methods disclosed herein. As noted above, such devices may access one or more computer-readable media that embody computer-readable instructions which, when executed by at least one computer, cause the at least one computer to implement one or more embodiments of the methods of the present subject matter. When software is utilized, the software may comprise one or more components, processes, and/or applications. Additionally or alternatively to software, the computing device(s) may comprise circuitry that renders the device(s) operative to implement one or more of the methods of the present subject matter. Furthermore, components of the presently-disclosed technology may be implemented using one or more computer-readable media.

Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other memory devices, and the like.

When information is displayed to a user, any number or type of displays may be used. The displays may be proximate to or remote from the computing device (or device(s)) used to execute one or more algorithms that provide the display functionality. For instance, in some embodiments, software is run locally, while in other embodiments some or all aspects of the software comprise a remote service accessible over any suitable network or networks.

Several embodiments of the present subject matter were presented above with regard to receiving information from and displaying information within a spreadsheet program. Any suitable spreadsheet program, including Microsoft Excel (available from Microsoft Corp. of Redmond, Wash., USA) can be used for such embodiments. However, in other embodiments, the subject matter can be implemented for use with other spreadsheet programs, one or more other programs that provide input and/or output functionality, or even in a stand-alone manner in which suitable data entry and/or display is provided by one or more software components that also provide the value stream mapping/analysis functionality.

The discussion above of a “user” is not intended to limit the present subject matter with regard to the person, persons, and/or entities that provide and receive data. For instance, one or more persons may provide data, while the same and/or different person or persons receive the results.

The material particularly shown and described above is not meant to be limiting, but instead serves to show and teach various exemplary implementations of the present subject matter. As set forth in the attached claims, the scope of the present invention includes both combinations and sub-combinations of various features discussed herein, along with such variations and modifications as would occur to a person of skill in the art.

What is claimed is:

1. A computerized method of value stream mapping, the method comprising:
displaying a user interface, wherein displaying comprises providing at least one data input form;
receiving textual data via the at least one data input form, the textual data defining at least one value stream comprising a plurality of process steps;
receiving a draw command; and
upon receipt of the draw command, computing a visual representation of a product flow and rendering at least one value stream map based on the received textual data defining the at least one value stream.

2. The method as set forth in claim 1, wherein displaying a user interface comprises displaying a data entry form comprising at least one process path data entry field and at least one process definition data entry field.

3. The method as set forth in claim 1, further comprising rendering at least one performance analysis chart based on the received textual data.

4. The method as set forth in claim 1, further comprising:
receiving textual data defining at least a first and second value streams, each stream comprising a plurality of process steps;
receiving cost information associated with each value stream; and providing at least one cost comparison between first and second value streams.

5. The method as set forth in claim 4,
wherein the first value stream comprises a current state map and the second value stream comprises a future state map; and
wherein the at least one cost comparison comprises an indication of at least one of the internal rate of return and net present value of converting the value stream of the current state map to the value stream of the future state map.

6. The method as set forth in claim 1, wherein receiving textual data comprises, for each process step:
receiving data identifying the process step;
receiving data identifying one or more flow paths to the process step, if any; and
receiving data identifying one or more flow paths from the process step, if any;
wherein rendering at least one value stream map comprises displaying a plurality of icons, each corresponding to a process step, and a plurality of connecting indicia corresponding to flow paths between process steps.

7. The method as set forth in claim 1, wherein rendering comprises drawing a lead time ladder correlated to the value stream map.

8. The method as set forth in claim 1, wherein displaying a user interface comprises displaying at least one financial data entry field, and wherein the method further comprises computing at least one cost measure for the value stream map.

9. The method as set forth in claim 8, further comprising rendering at least one chart illustrating the at least one computed cost measure.

10. Computer-executable code comprising program instructions rendered in at least one computer-readable medium, wherein the instructions, when executed by at least one computing device, cause the at least one computing device to perform a method of value stream mapping, the method comprising:
displaying a user interface, wherein displaying comprises providing at least one data input form;
receiving textual data via the at least one data input form, the textual data defining at least one value stream comprising a plurality of process steps;
receiving a draw command; and
upon receipt of the draw command, computing a visual representation of a product flow and rendering at least one value stream map based on the received textual data defining the at least one value stream.

11. Computer-executable code as set forth in claim 10, wherein displaying a user interface comprises displaying a data entry form at least one process path data entry field and at least one process definition data entry field.

12. Computer-executable code as set forth in claim 10, wherein the method of value stream mapping further comprises rendering at least one performance analysis chart based on the received textual data.

13. Computer-executable code as set forth in claim 10, wherein the method of value stream mapping further comprises:
receiving textual data defining at least a first and second value streams, each stream comprising a plurality of process steps;
receiving cost information associated with each value stream; and
providing at least one cost comparison between first and second value streams.

14. Computer-executable code as set forth in claim 13,
wherein the first value stream comprises a current state map and the second value stream comprises a future state map; and
wherein the at least one cost comparison comprises an indication of at least one of the internal rate of return and net present value of converting the value stream of the current state map to the value stream of the future state map.

15. Computer-executable code as set forth in claim 10, wherein receiving textual data comprises, for each process step:
receiving data identifying the process step;
receiving data identifying one or more flow paths to the process step, if any; and
receiving data identifying one or more flow paths from the process step, if any;
wherein rendering at least one value stream map comprises displaying a plurality of icons, each corresponding to a process step, and a plurality of connecting indicia corresponding to flow paths between process steps.

16. Computer-executable code as set forth in claim 10, wherein rendering comprises drawing a lead time ladder correlated to the value stream map.

17. Computer-executable code as set forth in claim 10, wherein displaying a user interface comprises displaying at least one financial data entry field, and wherein the method further comprises computing at least one cost measure for the value stream map based on data provided via the at least one financial data entry field.

18. Computer executable code as set forth in claim 17, wherein the method of value stream mapping further comprises rendering at least one chart illustrating the at least one computed cost measure.

19. A computer system comprising a display and at least one computing device, the system adapted to:
display a user interface, wherein displaying comprises providing at least one data input form;
receive textual data via the at least one data input form, the textual data defining at least one value stream comprising a plurality of process steps;
receive a draw command; and
upon receipt of the draw command, compute a visual representation of a product flow and render at least one value stream map based on the received textual data defining the at least one value stream.

20. The computer system as set forth in claim 19, wherein the at least one computing device is further adapted to render at least one performance analysis chart based on the received textual data.
